(19) United States
(12) Patent Application Publication
(10) Pub. No.: US 2026/0094490 A1
(43) Pub. Date: Apr. 2, 2026

(54) INFORMATION PROCESSOR, GAME CONTROL METHOD, AND COMPUTER READABLE NON-TRANSITORY RECORDING MEDIUM

(71) Applicant: Universal Entertainment Corporation, Tokyo (JP)

(72) Inventors: Atsushi KUMITA, Tokyo (JP); Keiji SEKIGUCHI, Tokyo (JP); Satoko BABA, Tokyo (JP); Nobuyuki KAWARAI, Tokyo (JP); Hikaru IINUMA, Tokyo (JP); Takuya YAMAGUCHI, Tokyo (JP)

(21) Appl. No.: 19/338,050

(22) Filed: Sep. 24, 2025

(30) Foreign Application Priority Data
Oct. 2, 2024 (JP) 2024-173183

(51) Int. Cl. G07F 17/32

(52) U.S. Cl. CPC G07F 17/3213

(57) ABSTRACT

An arrangement with balanced probability is easily designed even if a symbol display area is enlarged. An information processor is configured to: display a symbol display area where symbols are respectively rearranged in cells arranged to form a matrix with plural rows and plural columns; to run a unit game in which the symbols are rearranged in the symbol display area; to determine, when a special symbol is rearranged in the symbol display area in the unit game, whether the number of the cells in a column where the special symbol is rearranged is the maximum number; when the number of the cells is not the maximum number, to cumulatively increase the number of the cells in the column where the special symbol is rearranged, in subsequent execution of the unit game; and when the number of the cells is the maximum number, to award a benefit.

### CROSS-REFERENCE TO RELATED APPLICATION

The present application claims priority from Japanese Patent Application No. 2024-173183, which was filed on Oct. 2, 2024, the disclosure of which is herein incorporated by reference in its entirety.

### FIELD OF THE INVENTION

The present invention relates to an information processor, a game control method, and a computer readable non-transitory recording medium.

### BACKGROUND OF THE INVENTION

### Background Art

A known stationary slot machine and a recent smartphone (an information processor), on which a slot game application is installed, and a social network game are structured so that (i) random determination is performed in a normal game by betting a specified bet amount and (ii) symbols are rearranged and displayed based on a result of the random determination.

Generally, a “LEFT TO RIGHT” type is adopted for the determination of winning for rearranged and displayed symbols. The “LEFT TO RIGHT” type winning determination is a determination method where, among multiple symbols to be rearranged, winning is achieved when a predeterminer number or more of symbols of the same type are successively provided from a left column to a right column, regardless of the row. For example, U.S. Unexamined Patent Publication No. 2004/0053676 describes that the entire symbol display area is enlarged upward to increase the number of symbols to be rearranged and displayed. This makes it possible to rapidly increase the number of targets of winning determination.

However, the above-described known arrangement is disadvantageous in that, because the entire symbol display area is enlarged, the user may be at a loss where to focus his/her attention. Furthermore, because the enlargement of the entire symbol display area significantly increases the winning probability, it is necessary to decrease the probability of shifting to an advantageous state such as enlargement of the entire symbol display area and to shorten the duration of such an advantageous state, in order to balance the winning probability. As such, the game design is difficult.

Under these circumstances, an object of the present invention is to provide an information processor, a game control method, and a computer readable non-transitory recording medium, which make it easy to perform a design for achieving the balance of probability even if a symbol display area is enlarged.

### SUMMARY OF THE INVENTION

### Solution to Problem

An information processor of the present invention includes:
a display device configured to display a symbol display area where symbols are respectively rearranged in plural cells arranged to form a matrix with plural rows and plural columns;
a controller which is configured to run a unit game in which the symbols are rearranged in the symbol display area of the display device,
the controller being configured to execute processes of:
determining, when a special symbol is rearranged in the symbol display area in the unit game, whether the number of the cells in a column where the special symbol is rearranged is the maximum number;
when the number of the cells is not the maximum number, cumulatively increasing the number of the cells in the column where the special symbol is rearranged, in subsequent execution of the unit game; and
when the number of the cells is the maximum number, awarding a benefit.

According to the arrangement above, the number of the cells is cumulatively increased in the column where the special symbol is rearranged and the number of the rearranged symbols is cumulatively increased. It is therefore possible to continue the advantageous state for a long time as the winning probability is increased stepwise, and to urge the player to focus on the expanded column during a period until the benefit is awarded after the number of the cells reaches the maximum number. As a result, it is possible to keep the player's interest for a long time by urging him/her to focus on the special column where the special symbol is rearranged, and to increase the winning probability stepwise as a result of increase in number of the symbols rearranged in that column. On the other hand, because the benefit resulting from the special symbol is awarded only after the number of the symbols in the column is increased stepwise and reaches the maximum number, it is possible to avoid the benefit from being excessively awarded. In this way, while the number of the cells 210 is increased in each column to increase the winning probability, the awarding of the benefit is properly managed and suppressed. It is therefore easy to achieve an arrangement with the balanced probability even if the symbol display area is enlarged.

The information processor of the present invention may be arranged such that columns in each of which the number of the cells is cumulatively increased are continuously provided among the columns.

With this arrangement, by arranging the cells in the continuously-provided columns to be cumulatively increasable, the advantage after the expansion is further improved.

The information processor of the present invention may be arranged so that columns in each of which the number of the cells is cumulatively increased are not outermost columns among the columns in the symbol display area.

According to this arrangement, by excluding the outermost columns in the symbol display area from the columns in which the number of the cells is cumulatively increasable, it is possible to clearly display symbols forming a winning combination, while suppressing excessive increase in the winning probability.

The information processor of the present invention may be arranged so that, when the benefit is awarded, the controller resets the columns in the symbol display area to an initial state that is before cumulative increase of the number of the cells.

This arrangement makes it possible to avoid excessive continuation of the advantageous state.

A game control method of the present invention is
a game control method executed by a computer, including the steps of:
displaying, on a display device, a symbol display area where symbols are respectively rearranged in cells arranged to form a matrix with plural rows and columns;
running a unit game in which the symbols are rearranged in the symbol display area of the display device;
determining, when a special symbol is rearranged in the symbol display area in the unit game, whether the number of the cells in a column where the special symbol is rearranged is the maximum number; when the number of the cells is not the maximum number, cumulatively increasing the number of the cells in the column where the special symbol is rearranged, in subsequent execution of the unit game; and
when the number of the cells is the maximum number, awarding a benefit.

According to the arrangement above, the number of the cells is cumulatively increased in the column where the special symbol is rearranged and the area of that column is expanded, with the result that the number of the rearranged symbols is cumulatively increased. It is therefore possible to continue the advantageous state for a long time as the winning probability is increased stepwise, and to urge the player to focus on the expanded column during a period until the benefit is awarded after the number of the cells reaches the maximum number. Due to this, an arrangement with balanced probability is easily designed even if the symbol display area is enlarged.

A game program stored in a computer-readable non-transitory medium of the present invention causes
a computer including a display device to execute the steps of:
displaying a symbol display area where symbols are respectively rearranged in cells arranged to form a matrix with plural rows and columns;
running a unit game in which the symbols are rearranged in the symbol display area of the display device;
determining, when a special symbol is rearranged in the symbol display area in the unit game, whether the number of the cells in a column where the special symbol is rearranged is the maximum number; when the number of the cells is not the maximum number, cumulatively increasing the number of the cells in the column where the special symbol is rearranged, in subsequent execution of the unit game; and
when the number of the cells is the maximum number, awarding a benefit.

According to the arrangement above, the number of the cells is cumulatively increased in the column where the special symbol is rearranged and the area of that column is expanded, with the result that the number of the rearranged symbols is cumulatively increased. It is therefore possible to continue the advantageous state for a long time as the winning probability is increased stepwise, and to urge the player to focus on the expanded column during a period until the benefit is awarded after the number of the cells reaches the maximum number. Due to this, an arrangement with balanced probability is easily designed even if the symbol display area is enlarged.

### BRIEF DESCRIPTION OF THE DRAWINGS

FIG. 1 illustrates a schematic structure of an information processor in terms of display.

FIG. 2 is a block diagram of an electrical configuration of the information processor.

FIG. 3 is a functional block diagram of the information processor.

FIG. 4 is an explanatory diagram showing an example of column expansion.

FIG. 5 is an explanatory diagram showing an example in which a special symbol is rearranged in a column where cells have been expanded to the maximum number.

FIG. 6 is an explanatory diagram showing a game screen of a free game in a bonus state.

FIG. 7 is a flowchart of a game control process.

FIG. 8 is a flowchart of a benefit determination process.

FIG. 9 is a flowchart of a bonus state execution process.

### DESCRIPTION OF THE PREFERRED EMBODIMENTS

The following will describe an embodiment of the present invention with reference to figures.

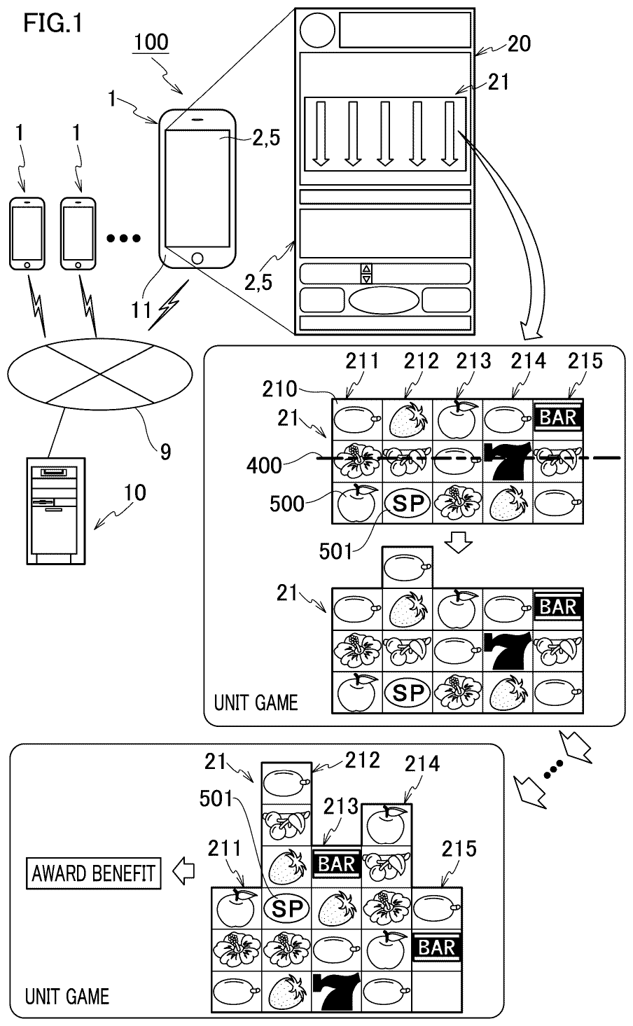

As shown in FIG. 1, an information processor 1 is connected to a server 10 via the Internet 9 to be able to perform data communication with the server 10. The information processor 1 and the server 10 constitute a game system 100. The game system 100 is not limited to this arrangement, and may be constituted only by the information processor 1. The information processor 1 may indicate a game system including a terminal device such as a smartphone and a server, and functions of the information processor 1 which will be described in the present embodiment may be that of any component of the game system.

The following description may presuppose that a user has logged in the server 10 through the information processor 1. For example, the user inputs a user ID and a password to the information processor 1, and the log-in of the user is authenticated by the server 10 through a communication line. The information processor 1 may store log-in information for this log-in authentication and the user may be able to automatically log in the server 10 by means of the stored log-in information at activation of a game, without requiring the user to input the information. Alternatively, in the information processor 1, the user may automatically log in the server 10 by using stored log-in information, as biometrics authentication of the user is performed at the activation of the game by the user. In this regard, known ones such as face, fingerprint, retina, iris, vein patterns, voiceprint, and the like can be used as biometric information used for the biometrics authentication. As such, the server 10 allows the user to log in the information processor 1 and to execute a game.

In information processors 1, shared application software is installed from an application software server or the like corresponding to the OS (Operating System) of each information processor 1. In the present embodiment, a slot game is playable as a game element of the application software installed in the information processor 1. That is, the user is allowed to play the slot game on this application software. The slot game may be an add-in of the application software. That is, the slot game may be independent from the application software and may be provided as an additional function of the application software by the application software server, the server 10, etc. The application software may allow the player to play plural types of slot games which are different in effects or rules.

As shown in FIG. 1, the information processor 1 of the present embodiment is a so-called smartphone and includes a display 2 provided on the front surface of a housing 11, a touch panel 5 provided on the display 2, a memory 3, and a controller 4. The information processor 1 is not limited to this, and may be a mobile device or a desktop device. Examples of a mobile information processor 1 include mobile information devices such as a portable computer, a laptop computer, a tablet PC, a handheld PC, and a PDA (Personal Data Assistant). The information processor 1 may be a stationary slot machine. In addition, the information processor 1 may have a device capable of accepting a physical or data game value (described later).

The display 2 is a display device which is able to display images. The display method of the display 2 is, for example, liquid crystal, organic electroluminescence, CRT (Cathode Ray Tube), or plasma. The touch panel 5 makes it possible to detect the coordinates of a part touched by a user's finger or the like. The touch panel 5 adopts a known technology such as electromagnetic induction and electrostatic capacity. The information processor 1 is configured to determine an object on a screen touched by the user, or the state of touching such as swipe and the like based on the coordinates detected by the touch panel 5 and to make a response according to a determination result. The display device may be partially or entirely mechanical.

In the present embodiment, the touch panel 5 is configured to operate as an input device and to accept a swipe input, a touch input, and the like. However, the present embodiment is not limited to this. For example, a microphone or a camera may be adopted as an input device and may receive user's voice or a gesture as an instruction input.

The touch panel 5 may not be provided on the front surface of the display 2. For example, the touch panel 5 may be provided on the back side of the housing 11, which is opposite to the display 2. Alternatively, the touch panel 5 may be provided at a part of the display 2.

The display 2 is configured to display a slot game screen 20. The slot game screen 20 is provided with a symbol display area 21 where symbols 500 are varied and stopped as a game (a normal game or a free game) starts. The symbol display area 21 has, in an initial state, multiple cells 210 arranged in a matrix with multiple rows and columns. A symbol is rearranged in each cell 210. In the present embodiment, the symbol display area 21 is provided with a first scroll area 211, a second scroll area 212, a third scroll area 213, a fourth scroll area 214, and a fifth scroll area 215 as the columns. These columns are expandable. The expansion of the columns will be discussed later. After the scrolling (variable display) of the symbol columns (described later) in each row, a symbol 500 may be rearranged in each of the cells 210. After the scrolling (variable display) of the symbol column (described later) is performed in each of the cells 210, the symbol 500 may be rearranged. In each of the scroll areas 211 to 215, in the initial state, three cells 210 in total are arranged in the up-down direction (scroll direction in the present embodiment). That is, in the initial state, 15 cells 210 in total are arranged in the symbol display area 21 to form a matrix of five columns and three rows. Each cell 210 is a setting area defining a stop position of a symbol 500, and may be displayed or hidden. The number of the cells 210 in the symbol display area 21 in the initial state is not limited to the above. A symbol 500 is rearranged in each cell 210. One symbol 500 may be rearranged in one cell 210, or one symbol 500 may be rearranged to occupy two or more cells 210.

The memory 3 is configured to store various programs including a game program executed by the controller 4 and various data used in the various programs. The memory 3 may be a conceptual storage area in the game system 100, or may be implemented either in the information processor 1 or in the server 10. The functions of the memory 3 may be separately implemented in the information processor 1 and the server 10, or the functions of the memory 3 may be implemented both in the information processor 1 and the server 10. That is, in the game program executed in the information processor 1, if data stored in the server 10 is necessary, the information processor 1 may request the data to the server 10 and the server 10 may respond to such a request of the data.

The controller 4 functioning as a control unit is configured to execute various types of processes in accordance with the game program stored in the memory 3. The controller 4 may be a conceptual execution device in the game system 100, or may be implemented either in the information processor 1 or in the server 10. The functions of the controller 4 may be separately implemented in the information processor 1 and the server 10, or the functions of the controller 4 may be implemented both in the information processor 1 and the server 10.

As such, the game system 100 functions as a single computer including (i) the information processor 1 having the input device (touch panel 5) and the output device (display 2) and (ii) the information processor 1 and/or the server 10 serving as the memory 3 and the controller 4.

The information processor 1 configured as described above expands, in the symbol display area 21, a column in which the special symbol 501 is rearranged. The information processor 1 awards a special benefit when the special symbol 501 is rearranged in a column that has been maximally expanded.

The expansion of the columns is specifically described. As shown in FIG. 1, the columns in the symbol display area 21 are expandable. The expansion of a column indicates that the area of the column is expanded so that the number of cells 210 arranged in one column is increased. For example, when the display device is mechanical, increase in the number of cells 210 in one column may be indicated by turning on the backlight of the cells 210. In the present embodiment, the second scroll area 212, the third scroll area 213, and the fourth scroll area 214 are arranged to be expandable. In this way, by arranging the continuously-provided columns to be expandable, the advantage after the expansion is further improved. It is noted that the first scroll area 211 and the fifth scroll area 215 are excluded from the expandable columns. In this way, by excluding the outermost columns in the symbol display area 21 from the expandable columns, it is possible to clearly display symbols forming a winning combination, while suppressing excessive increase in the winning probability. Alternatively, at least one of the columns may be expanded, or at least one of the columns may be excluded from the expandable columns. The expansion of a column is not limited to the increase in size of the area of the column. For example, the expansion of a column may be achieved by reducing the size of each cell 210 while maintaining the size of the area of the column, thereby increasing the number of cells 210 in the area of the column.

The expansion of a column is executed on condition that the special symbol 501 is rearranged in a cell 210 of an expandable column. A column having a cell 210 where the special symbol 501 is rearranged is expanded. The expansion of a column may be performed in a unit game (described later) in which the special symbol 501 is rearranged. The expansion of a column may be performed in a unit game (e.g., the next unit game) subsequent to a unit game in which the special symbol 501 is rearranged. The size of the area of one cell 210 in an expanded column may be different from the size of the area before the expansion.

The expansion of a column is done cumulatively. When the number of cells 210 is increased on account of the expansion of a column, the number after the increase is continuously used in subsequent unit games. When the special symbol 501 is rearranged in a cell 210 of the expanded column, the column is further expanded. Each column is expandable up to the maximum number of cells 210 in each column, which is determined in advance. In the present embodiment, the maximum number (six) is the same between all columns, but it may be different between the columns.

The initial state of the symbol display area 21 shows a state of the symbol display area 21 after reset. The initial state of the symbol display area 21 is a state in which multiple cells 210 are arranged in a matrix manner, and is a state before any column is expanded. The reset may be performed after a special benefit is awarded. The reset may be performed based on random determination. The random determination for determining whether to perform the reset may be symbol random determination for determining symbols 500 to be rearranged, or may be independent random determination. The reset may be performed when a predetermined number of unit games is executed after the expansion of a column. A column that is the target of the reset may be only a column where the condition of awarding a special benefit has been achieved, or may be all columns.

The condition of awarding the special benefit is rearrangement of the special symbol 501 in a column in which the number of cells 210 has been maximally expanded. For example, the special benefit may be awarded in a unit game in which the condition of awarding the special benefit has been achieved. To be more specific, the special benefit may be a fixed payout that is additionally awarded. Alternatively, for example, the special benefit may be replacement of a rearranged symbol 500 with an advantageous symbol in a unit game in which the condition of awarding the special benefit has been established. To be more specific, the special benefit may be replacement of at least one rearranged symbol 500 with a wild symbol that can substitute another symbol 500, in a unit game in which the condition of awarding the special benefit has been established. Furthermore, for example, the special benefit may be awarded after a unit game in which the condition of awarding the special benefit is achieved. To be more specific, the special benefit may be a unit game that is more advantageous than the normal game and is executed after the condition of awarding the special benefit is established. To be more specific, a unit game that is more advantageous than the normal game may be execution of the unit game more than once, with all expandable columns being maximally expanded.

The information processor 1 configured in this way is programmed so that the controller 4 executes the following processes (A1) to (A5). In other words, the game program stored in the memory 3 which will be described later as a storage unit causes the game system 100 functioning as a computer to execute the processes (A1) to (A5) described below. To be more specific, the process (A1) is a process of displaying a symbol display area 21 where symbols 500 are respectively rearranged in plural cells 210 that are arranged to form a matrix with plural rows and columns. The process (A2) is a process of executing a unit game in which the symbols 500 are rearranged in the symbol display area 21 of the display 2. The process (A3) is executed when the special symbol 501 is rearranged in the symbol display area 21 in the unit game, and is a process of determining whether the number of the cells 210 in a column where the special symbol 501 is rearranged is the maximum number. The process (A4) is performed when the determination result indicates that the number of the cells 210 is not the maximum number, and is a process of cumulatively increasing the number of the cells 210 in the column where the special symbol 501 is rearranged, in subsequent execution of the unit game. The process (A5) is executed when the determination result indicates that the number of the cells 210 is the maximum number, and is a process of awarding a benefit.

In this way, the number of the cells 210 is cumulatively increased in the column where the special symbol 501 is rearranged and the area of that column is expanded, and hence the number of the rearranged symbols 500 is cumulatively increased. It is therefore possible to continue the advantageous state for a long time as the winning probability is increased stepwise, and to urge the player to focus on the expanded column during a period until the benefit is awarded after the number of the cells 210 reaches the maximum number. As a result, it is possible to keep the player's interest for a long time by urging him/her to focus on the special column where the special symbol 501 is rearranged, and to increase the winning probability stepwise as a result of increase in number of the symbols 500 rearranged in that column. On the other hand, because the benefit resulting from the special symbol 501 is awarded only after the number of the symbols in the column is increased stepwise and reaches the maximum number, it is possible to avoid the benefit from being excessively awarded. In this way, while the number of the cells 210 is increased in each column to increase the winning probability, the awarding of the benefit is properly managed and suppressed. It is therefore easy to achieve an arrangement with the balanced probability even if the symbol display area 21 is enlarged.

As the information processor 1 including the above-described program executes the processes (A1) to (A5), a game control method of executing the processes (A1) to (A5) by means of the information processor 1 (computer) is embodied. In other words, the information processor 1 includes plural processing units configured to execute the respective processes (A1) to (A5). While the following description deals with the information processor 1, the processes and operation of the information processor 1 can be interpreted as those of a game program or a game control method stored in a non-volatile recording medium. The processes executed by the controller 4 may be executed only in the information processor 1, or may be executed by the game system 100 including the server 10. That is, the processes and operation of the information processor 1 may be interpreted as those of the game system 100. The information processor 1, the game control method, and the game program can improve the interface as follows. Because each column develops (i.e., the number of cells 210 is cumulatively increased) under a specific condition, it is possible to clearly visualize “which column is developing now” and “which column is especially hopeful”. In other words, the user can intuitively grasp the game situation. In this way, visual understandability of the game situation is improved by visual feedback. Furthermore, because a developing column is clearly shown in the screen, the disclosure provides the player with the joy of nurturing over not in one execution of the unit game but in plural times of execution of the unit game. In this way, it is possible to visually provide the joy of long-term development to the player. Furthermore, because the line of sight of the player is guided to the expanded column, the player is able to understand the steps for obtaining a benefit, without needing complicated explanations. To put it differently, even if the game is complicated, the user interface allows the player to easily and intuitively assume what happens next. In this way, it is possible to provide the user interface in which the element to be focused on is clarified.

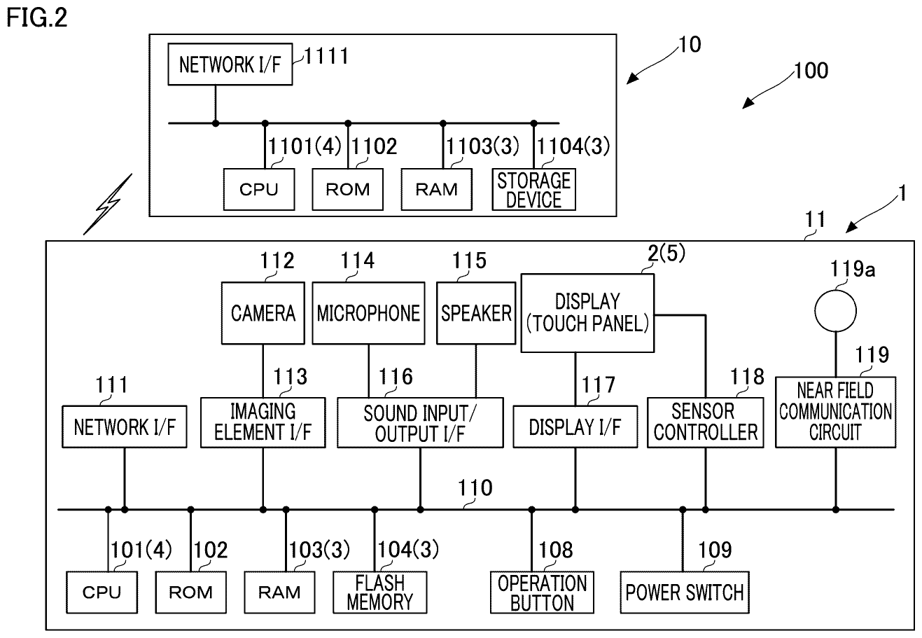

The following will describe an example of a specific electric configuration of the game system 100 formed of the information processor 1 and the server 10, with reference to FIG. 2. As shown in FIG. 2, the information processor 1 includes, in the housing 11, a CPU 101, a ROM 102, a RAM 103, a flash memory 104, an operation button 108, a power switch 109, a bus line 110, a network I/F 111, a camera 112, an imaging element I/F 113, a microphone 114, a speaker 115, a sound input/output I/F 116, a display I/F 117, a sensor controller 118, a near field communication circuit 119, and an antenna 119a of the near field communication circuit 119.

The server 10 is a so-called computer including a CPU 1101, a ROM 1102, a RAM 1103, a storage device 1104 such as a hard disk drive and the like, and a network I/F 1111.

The CPU (Central Processing Unit) 101 functions as a main feature of the controller in the information processor 1, and controls the entire operation of the information processor 1. The CPU 1101 functions as a main feature of the controller in the server 10, and controls the entire operation of the server 10. The CPUs 101 and 1101 therefore function as controllers which control the entire operation of the game system 100. The ROM (Read Only Memory) 102 is configured to store programs used for driving the CPU 101, such as an IPL (Initial Program Loader).

The RAM (Random Access Memory) 103 and the RAM 1103 are used as a work area of the CPU 101 and the CPU 1101. The operation button 108 is used for, e.g., initial setting of the information processor 1. The power switch 109 is used for turning on/off the power source of the information processor 1.

The flash memory 104 functioning as the memory 3 is a non-transitory computer readable recording medium which stores the game program, a program for communication, and plural sets of data such as image data and sound data. The storage device 1104 is a non-transitory computer readable medium which functions as a database and which is configured to store game data of each information processor 1. In response to a request from the game program in the information processor 1, the server 10 returns as needed a response referring to the database in the storage device 1104.

For example, the flash memory 104 stores various programs which include the game program executed by the CPU 101 functioning as a controller and various data used in the various programs. In other words, this program causes the computer, i.e., the information processor 1 including the CPU 101 and the flash memory 104 to execute processes of these various programs. In a case in which the information processor 1 is considered as the game system 100, the flash memory 104 and the storage device 1104 store various programs including the game program executed by the CPU 101 or the CPU 1101 serving as controllers and various data used in the various programs. In other words, this game program causes the information processor 1 which is the game system 100 including the CPU 101, the CPU 1101, the flash memory 104, and the storage device 1104 to execute processes of these various programs. As such, the processes and operation of the information processor 1 can be interpreted as those of a program or a game control method. As such, the processes and operation of the information processor 1 can be interpreted as those of a program or a game control method.

The data and program in the flash memory 104 and the storage device 1104 may be stored in advance at the stage of factory shipment, or may be downloaded from an unillustrated server or the like via communication means and then stored. The communication means may be an interactive communication passage such as the Internet and a cable TV, or may be one-way broadcasting. Alternatively, the data and program stored in the memory flash memory 104 and the storage device 1104 may be stored in a recording medium such as a floppy disk, a CD-ROM, a DVD-ROM, an MO (optical magnetic disk), and a flash memory and may be read from the recording medium and installed in the memory according to need.

Each of the network I/F (Interface) 111 and the network I/F 1111 is an interface provided for data communication using a communication network such as the Internet. The camera 112 is a built-in image capturing means for capturing an image of an object so as to obtain image data under the control of the CPU 101. The imaging element I/F 113 is a circuit for controlling the camera 112. The microphone 114 is a built-in sound collection means to which sound is input. The sound input/output I/F 116 is a circuit for processing the input and output of a sound signal between the microphone 114 and the speaker 115 under the control of the CPU 101. The display I/F 117 is a circuit for sending image data to the display 2 under the control of the CPU 101. The display 2 is provided on the front surface of the housing 11. The sensor controller 118 is a circuit for receiving an input from the touch panel 5 provided on the display 2. The near field communication circuit 119 is a communication circuit based on NFC (Near Field Communication) (Registered Trademark), Bluetooth (Registered Trademark), or the like. The bus line 110 is an address bus, a data bus, or the like provided for electrically connecting the components such as the CPU 101.

The following will describe a slot game. The slot game is playable by the user as a game element of the installed application software. The slot game is a game in which (i) symbols 500 are varied and then stopped (rearranged) in the symbol display area 21 and (ii) a gaming value is awarded based on a combination of the symbols 500 displayed in the symbol display area 21. A state in which symbols 500 are displayed after being varied and stopped in the symbol display area 21 is referred to as “rearrangement”. In the slot game, a free game which is advantageous for the user as compared to a normal game may be executed in a case where (i) the normal game is executed and (ii) a predetermined condition is satisfied in the normal game.

The slot game starts on the premise of consumption of an accumulable gaming value. The gaming value is consumed as a condition of executing the normal game in a normal state, and can be awarded as a game result. That is, as the user plays the slot game (unit game) once by betting the gaming value, the user may acquire the benefit such as the gaming value, etc. as a result of the slot game. As described above, the gaming value may be a game point which is simulatingly used as a substitute for a credit in a game and which does not include valuable information, or may be a coin, a banknote, or electrically valuable information equivalent to the coin or the banknote. The gaming value may be information which is used exclusively for starting the slot game and which does not have a monetary value. Hereinafter, the gaming value may be referred to as a credit. The number of gaming values used for betting may be referred to as a bet amount.

The “unit game” is a series of operations from the start of receiving of a bet to the establishment of a prize (i.e., a symbol combination satisfies a predetermined relation). That is, the unit game includes a single bet time of receiving a bet, a single game time of rearranging symbols, and a single payout time of a payout process of awarding a payout. When no prize is established, the payout process is not performed because there is no payout. A motion in the unit game may indicate an effect displayed on the display device, may indicate internal processing, or may be both.

A bonus state encompasses execution of the free game at least once. The free game is a game in which a payout is larger than that in the normal game. Typically, the free game is set so that a symbol combination is easily established as compared to the normal game so that the user is more likely to be awarded a large payout than in the normal game. The free game is a game executable with a small amount of gaming values as compared to the normal game. In this regard, the “executable with a small amount of gaming values” encompasses a bet of zero gaming value. The free game therefore may be a game which is executed without a bet of a gaming value and which awards an amount of gaming values based on rearranged symbols. In other words, the bonus state may be a game started without the consumption of a gaming value. Meanwhile, the normal game is a game which is executed on condition of betting of a gaming value and which awards an amount of gaming values based on rearranged symbols. In other words, the normal game is a game started with the consumption of a gaming value.

The following will describe winning determination in the slot game. Winning determination lines 400 (one of these lines is shown in FIG. 1 as an example) are set in the symbol display area 21. Each winning determination line 400 is formed of five cells 210 selected from the respective scroll areas 211 to 215. While the winning determination is performed in advance before the rearrangement of symbols 500, a winning result is shown to the user as the symbols 500 are rearranged on the winning determination line 400.

To be more specific, the winning determination line 400 is formed of five cells 210, i.e., one cell 210 included in the first scroll area 211, one cell 210 included in the second scroll area 212, one cell 210 included in the third scroll area 213, one cell 210 included in the fourth scroll area 214, and one cell 210 included in the fifth scroll area 215. Hereinafter, the winning determination line may be referred to as a winning line or a payline. On the winning determination line 400, the above-described five cells 210 are arranged in order from the cell 210 of the first scroll area 211 to the cell 210 of the fifth scroll area 215. That is to say, on the winning determination line 400, the cell 210 of the second scroll area 212 is provided next to the cell 210 of the first scroll area 211. The cell of the third scroll area 213 is next to the cell 210 of the second scroll area 212. The cell 210 of the fourth scroll area 214 is next to the cell 210 of the third scroll area 213. The cell 210 of the fifth scroll area 215 is next to the cell 210 of the fourth scroll area 214. This order of the cells is identical with the order in which the scroll of the symbols 500 stops in the scroll areas 211 to 215. That is to say, the scrolling of the symbols 500 stops in order from the first scroll area 211 to the fifth scroll area 215.

The winning determination in the normal game and the free game is performed based on a winning determination method of a so-called “LEFT TO RIGHT” type. According to the “LEFT TO RIGHT” type, when a predetermined number or more (for example, three to five) of symbols of the same type are successively arranged so as to form a line across from the first scroll area 211 to the fifth scroll area 215 of the symbol display area 21, winning is achieved (a payout is awarded). That is, in the “LEFT TO RIGHT” type, winning is achieved when the same symbols 500 are rearranged in the first scroll area 211, the second scroll area 212, and the third scroll area 213, respectively. In other words, the “LEFT TO RIGHT” type is a system in which the winning determination lines 400 are set to cover all patterns. Alternatively, the winning determination method may be of a payline type. According to the payline type, in any of the winning determination lines 400, when (i) symbols of the same type are successively rearranged in the above-described order from the first scroll area 211 and (ii) the number of these symbols is a predetermined number or more, it is determined as the winning regarding this type of the symbols 500. In other words, the payline type is a system where the winning determination line 400 is limited as compared to the “LEFT TO RIGHT” type.

When the winning determination is performed so as to determine the shift to the bonus state in which the free game is performed, a winning determination method referred to as a scatter method is used. According to the scatter type, when (i) symbols of the same type are rearranged in the symbol display area 21 and (ii) the number of these symbols is a predetermined number or more, it is determined that winning is achieved. For example, when three or more trigger symbols are rearranged, shift from the normal game to the bonus state occurs. The advantage of the bonus state may change depending on the number of the rearranged trigger symbols. For example, the number of times of execution of the free game in the bonus state may be changed according to the number of trigger symbols. For example, a fixed payout when shifting to the bonus state may be increased in accordance with the number of trigger symbols. The symbols used for determination in the scatter type are excluded from symbols each of which can be substituted by a wild symbol. In the following explanation, the trigger symbol may be referred to as a bonus symbol.

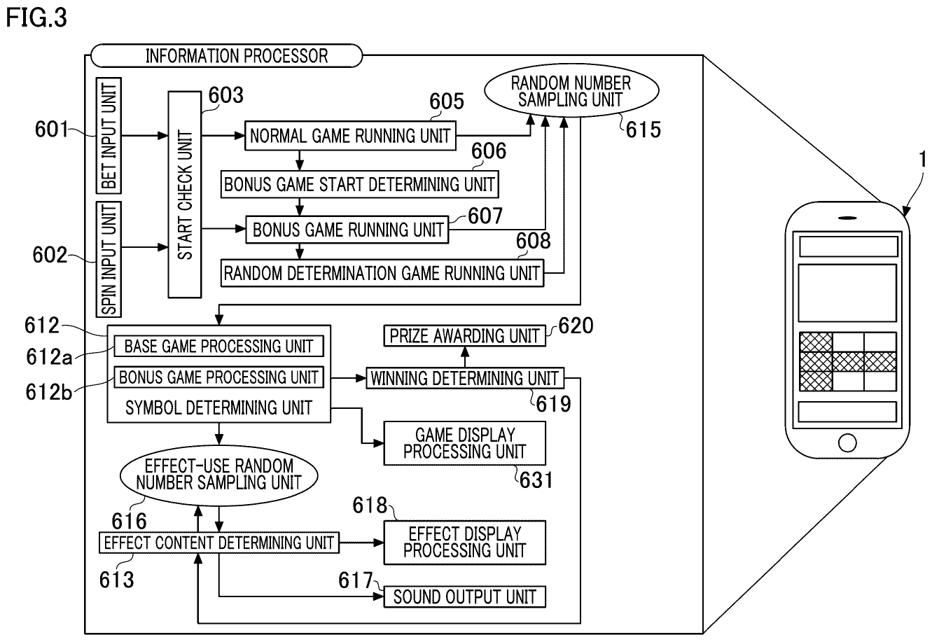

As shown in FIG. 3, the information processor 1 has the following functions to execute the slot game described above. To be more specific, the information processor 1 includes a BET input unit 601 and a spin input unit 602. The BET input unit 601 has a function of receiving a bet in response to a user operation. The spin input unit 602 has a function of receiving a user operation, i.e., an instruction to start a game. For example, the BET input unit 601 and the spin input unit 602 are embodied by the touch panel 5.

The information processor 1 further includes a start check unit 603, a normal game running unit 605, a bonus game start determining unit 606, a bonus game running unit 607, a random determination game running unit 608, a random number sampling unit 615, a symbol determining unit 612, an effect-use random number sampling unit 616, an effect content determining unit 613, a sound output unit 617, an effect display processing unit 618, a winning determining unit 619, a prize awarding unit 620, and a game display processing unit 631.

The normal game running unit 605 has a function of running a normal game which is a base game, on condition that the BET input unit 601 is operated. The bonus game start determining unit 606 is configured to determine whether to execute a bonus game, based on a combination of symbols rearranged in the normal game. In other words, the bonus game start determining unit 606 has functions of determining that winning is achieved in the bonus game when a bonus trigger condition is established, and activating the bonus game running unit 607 to run the bonus game from the next unit game. The random determination game running unit 608 has a function of randomly determining prizes including the bonus game. As this function is executed after the execution by the bonus game running unit 607, the bonus game can be repeatedly performed.

The symbol determining unit 612 includes a base game processing unit 612a and a bonus game processing unit 612b. The symbol determining unit 612 including these processing units 612a and 612b has functions of: determining symbols to be rearranged based on a random number given from the random number sampling unit 615; rearranging the determined symbols in a game area 291 of the display 2; outputting rearrangement information of the symbols to the winning determining unit 619; and outputting an effect instruction signal to the effect-use random number sampling unit 616 based on a combination of the rearranged symbols.

The effect-use random number sampling unit 616 has functions of: when receiving the effect instruction signal from the symbol determining unit 612, extracting an effect-use random number; and outputting the effect-use random number to the effect content determining unit 613. The effect content determining unit 613 has functions of: determining an effect content by using the effect-use random number; outputting image information of the determined effect content to the effect display processing unit 618; and outputting audio and illumination information of the determined effect content to the sound output unit 617.

The winning determining unit 619 has functions of: when receiving the rearrangement information of the symbols, determining whether winning is achieved based on a symbol combination; when determining that the winning has been achieved, calculating a payout amount based on a formed winning combination; and outputting, to the prize awarding unit 620, a payout signal which is based on the payout amount. The prize awarding unit 620 has a function of paying out a gaming value to the user.

Although not illustrated, the output content output by each of the above processing units is suitably transmitted to the server 10 which is connected via a communication line.

In the present embodiment, processes and operations are described with the assumption that the information processor 1 which is a smartphone has the above-described functions. However, these functions may be distributed to the components of the game system 100. For example, random determination of a result of a slot game may be performed by the server 10. That is, the information processor 1 may be formed of the game system 100.

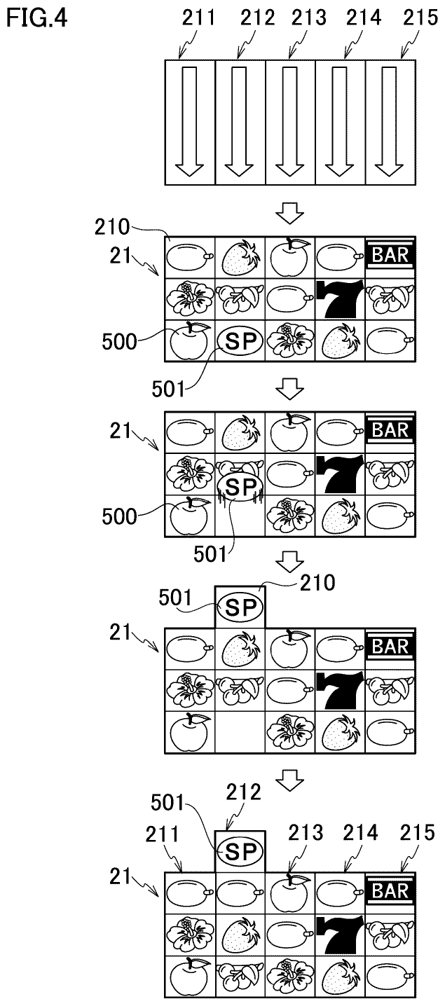

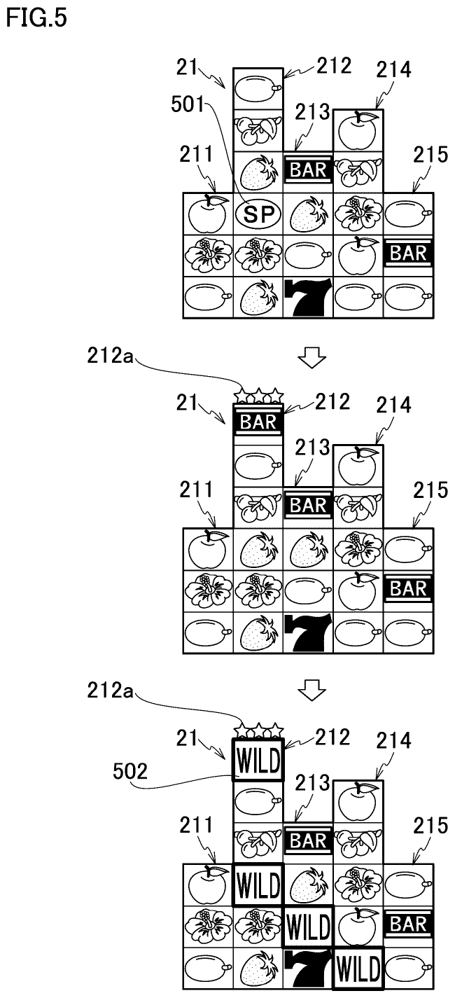

Now, with reference to FIG. 4 and FIG. 5, the following will describe an example of specific display on the symbol display area 21 regarding column expansion.

As shown in FIG. 4, to begin with, the symbols 500 are varied and displayed in the scroll areas 211 to 215 in the symbol display area 21. Then the symbol 500 is rearranged in each cell 210 of the symbol display area 21. When the special symbol 501 is rearranged, an effect of moving up the special symbol 501 is performed in the column where the special symbol 501 is rearranged (the second scroll area 212 in the example shown in FIG. 4). Then the column where the special symbol 501 is rearranged is expanded upward, and a cell 210 is added. The special symbol 501 having moved up is placed in the added cell 210. In this way, the column is expanded. A symbol 500 is shifted downward to fill the blank cell 210 where the special symbol 501 was rearranged. To put it differently, to the column in which the special symbol 501 is rearranged, a symbol 500 to be rearranged is newly added.

The following will describe a case where, as shown in FIG. 5, the special symbol 501 is rearranged in a column (second scroll area 212 in the example of FIG. 4) where the number of the cells 210 has been expanded to the maximum (six in the present embodiment). In this case, for example, after an effect of moving up the special symbol 501 is performed in the same manner as in the example of FIG. 4, the special symbol 501 is hidden. Thereafter, in the same manner as in the example of FIG. 4, a symbol 500 is shifted downward to fill the blank cell 210 where the special symbol 501 was rearranged. To put it differently, in the column in which the special symbol 501 is rearranged, a symbol 500 to be rearranged is newly added. Then an effect 212a is performed to indicate that a special benefit is to be awarded. The special benefit is then awarded. For example, in an example shown in FIG. 5, replacement of the rearranged symbol 500 with a wild symbol 502 which can substitute another symbol 500 is awarded as the special benefit. Alternatively, how many times each column has reached the maximum number (i.e., the number of times of awarding the special benefit) may be stored, and the special benefit may be changed in accordance with the number of times.

The special symbol 501 may be a symbol 500 which substitutes a substitute symbol (not illustrated) after the rearrangement. In other words, after the substitute symbol is rearranged, a symbol 500 substituting the substitute symbol may include the special symbol 501. Other symbols that can substitute the substitute symbol may be, for example, a symbol that awards a fixed payout. To be more specific, the symbol that awards a fixed payout may have a function of awarding a payout calculated by multiplying a number associated with the symbol by a bet amount, when the symbol is rearranged.

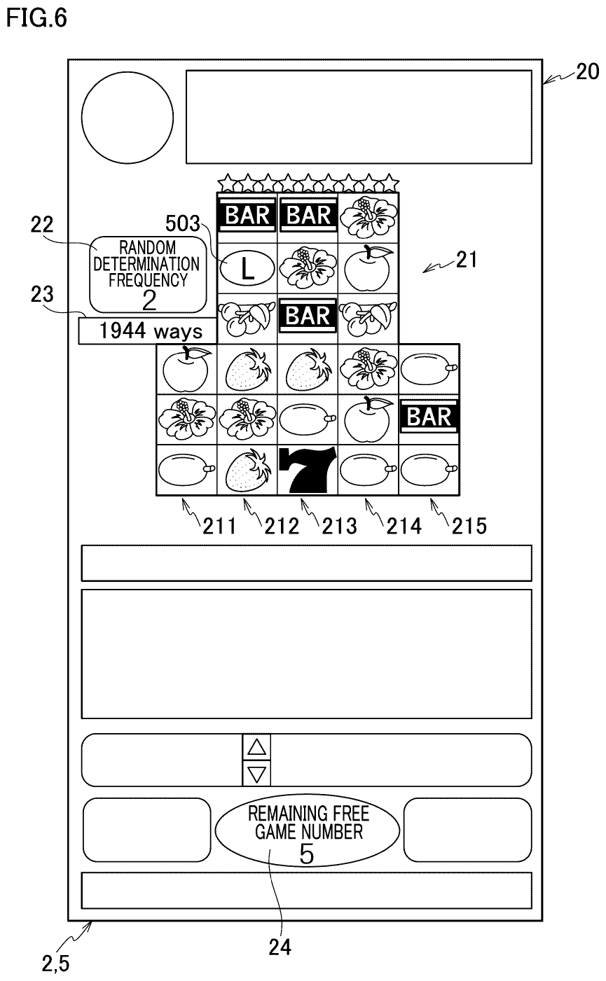

As shown in FIG. 6, the special benefit may be execution of the free game more than once. In the example shown in FIG. 6, the free game is executed in a state in which, in the symbol display area 21, the cells 210 of the expandable columns (scroll areas 212 to 214) have been maximally expanded. In the free game, an additional random determination symbol 503 is included in the rearranged symbols 500. When the additional random determination symbol 503 is rearranged, additional random determination is executed to determine an additional benefit including the continuation of the free game, after the end of the free game. The additional random determination is executed a number of times identical with the number of the stopped additional random determination symbols 503, over multiple executions of the free game. In the free game, an additional random determination frequency display area 22, a winning determination line number display area 23, and a remaining free game number display area 24 are provided in the slot game screen 20. The additional random determination frequency display area 22 displays how many times the additional random determination has been executed up to the present. The winning determination line number display area 23 displays the current number of winning determination lines 400. Although not illustrated, the winning determination line number display area 23 may be displayed in the normal game, too. The remaining free game number display area 24 displays the remaining number of times of execution of the free game. The remaining free game number display area 24 may be displayed in the area where the spin button is displayed in the normal game. The spin button is an area provided to confirm the bet and start the slot game.

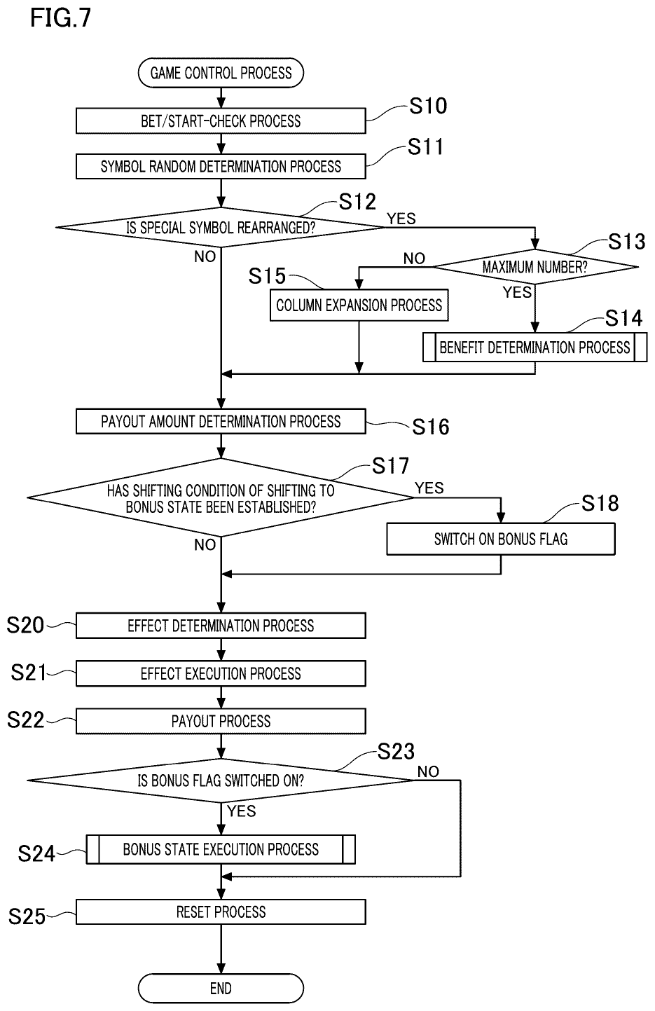

The following will describe a game control process executed by the CPU 101 of the information processor 1, with reference to FIG. 7.

To begin with, the CPU 101 executes a bet/start-check process (S10). In this bet/start-check process, a credit amount (the number of coins) to be betted is determined by a touch input made to the display 2 of the information processor 1. Subsequently, the betted credit amount is stored in a bet counter of the RAM 103. When the betting is performed, the betted credit amount is subtracted from a value on a coin counter provided in the RAM 103. In the bet/start-check process, furthermore, the CPU 101 determines whether a touch input has been made to the spin button. When a touch input has been made to the spin button, the process proceeds to S11 and the slot game progresses.

Subsequently, the CPU 101 executes a symbol random determination process (S11). As described above, in the symbol random determination, the CPU 101 performs a rearranged symbol determination process of selecting rearranged symbols from an unillustrated symbol array to be displayed in the symbol display area 21. In this process, to-be-stopped symbols are randomly selected from among the symbols 500 arranged in five video reels (scroll areas 211 to 215). These to-be-stopped symbols are pieces of symbol data to be displayed in the symbol display area 21. In this way, the symbols 500 displayed in the symbol display area 21 are determined. The CPU 101 then stores the determined to-be-stopped symbols in a symbol storing area in the RAM 103.

When the rearrangement of the special symbol 501 is determined in the symbol random determination process, an additional symbol 500 is determined, too. That is to say, a symbol 500 which is added due to the expansion of a column (see FIG. 4) and a symbol 500 which is added due to the hiding of the special symbol 501 (see FIG. 5) are determined.

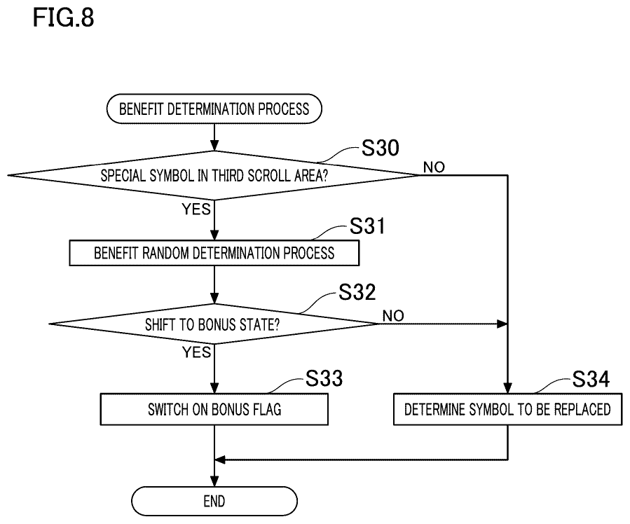

The CPU 101 then determines whether the special symbol 501 is rearranged in the symbol random determination process in the step S11 (S12). When the special symbol 501 is rearranged (YES in S12), the CPU 101 determines whether the number of cells 210 in the column where the special symbol 501 is rearranged is the maximum (S13). When the number of cells 210 in the column where the special symbol 501 is rearranged is the maximum (YES in S13), the CPU 101 executes a benefit determination process (S14). The benefit determination process will be described with reference to FIG. 8. When the number of cells 210 in the column where the special symbol 501 is rearranged is not the maximum (YES in S13), the CPU 101 executes a column expansion process (S15). To be more specific, in the column expansion process, a column to which a symbol 500 is added is specified, and which symbol 500 is to be added is determined.

When the special symbol 501 is not rearranged (NO in S12), after the step S14 or the step S15, the CPU 101 performs a payout amount determination process based on a result of the symbol random determination process (S16). In this process, determination is performed by the CPU 101 based on the number of symbols of the same type, which are to be rearranged (displayed) on a payline in the symbol display area 21. When the number of the symbols of the same type on the payline is a predetermined number or more (three to five), the CPU 101 uses a paytable stored in the RAM 103 and determines a payout amount (payout value) corresponding to the number of the to-be-arranged symbols of the same type. When the number of the symbols of any type to be rearranged is less than the predetermined number, a payout amount is zero (a payout value is zero). The determined payout amount (payout) is stored in a payout amount storage area in the RAM 103.

Subsequently, the CPU 101 determines whether three or more bonus symbols are rearranged in a symbol random determination process in the step S11 and a shifting condition of shifting to the bonus state has been established (S17). When it is determined in the step S13 that three or more bonus symbols are rearranged (YES in S17), the CPU 101 turns on a bonus flag (S18).

When the shifting condition of shifting to the bonus state is not established (NO in S17) or after the step S18, the CPU 101 executes an effect determination process (S20). The CPU 101 samples an effect-use random number, and randomly selects any of a plurality of predetermined effect contents. For example, the CPU 101 determines an effect of, in the symbol display area 21, scrolling and stopping the symbols having been determined in the random determination process of the step S11. To be more specific, for example, when a bonus symbol has been selected as a symbol to be stopped, during the scroll, an indication effect indicating that the bonus symbol will be stopped may be performed in the display area where the bonus symbol is to be stopped.

The CPU 101 then executes the determined effect at the determined time (S21). For example, the CPU 101 displays an effect image in the display 2 and outputs sound by means of the speaker 115. Furthermore, for example, the CPU 101 displays an image in which symbols on reels in the symbol display area 21 are scrolled and then to-be-stopped symbols are stopped. Further, for example, the CPU 101 displays an image in which symbols constituting winning are highlighted among stopped symbols and performs an effect of incrementing the owned credit amount. Further, for example, the CPU 101 performs an effect of shifting to the bonus state. Furthermore, for example, the CPU 101 displays, in the form of images, an effect of expanding a column and an effect of awarding the special benefit as shown in FIG. 4 and FIG. 5, in accordance with the effect content determined based on, for example, the information of the symbols 500 determined in the step S15.

Thereafter, when there is a credit amount to be added as a result of the game, the CPU 101 executes a payout process of adding the credit amount to the owned credit amount (S22). The payout process may be performed at a predetermined timing during the execution of an effect execution process (e.g., at a timing of the effect of incrementing the owned credit amount). The CPU 101 then finishes the sub routine. At this stage, for example, the CPU 101 may clear data which is stored in the working area of the RAM 103 and has become unnecessary at the end of each execution of the unit game. Examples of the data include a value on the bet counter of the bet number storage area in the unit game having been executed and the symbols randomly selected to be displayed in the symbol display area 21.

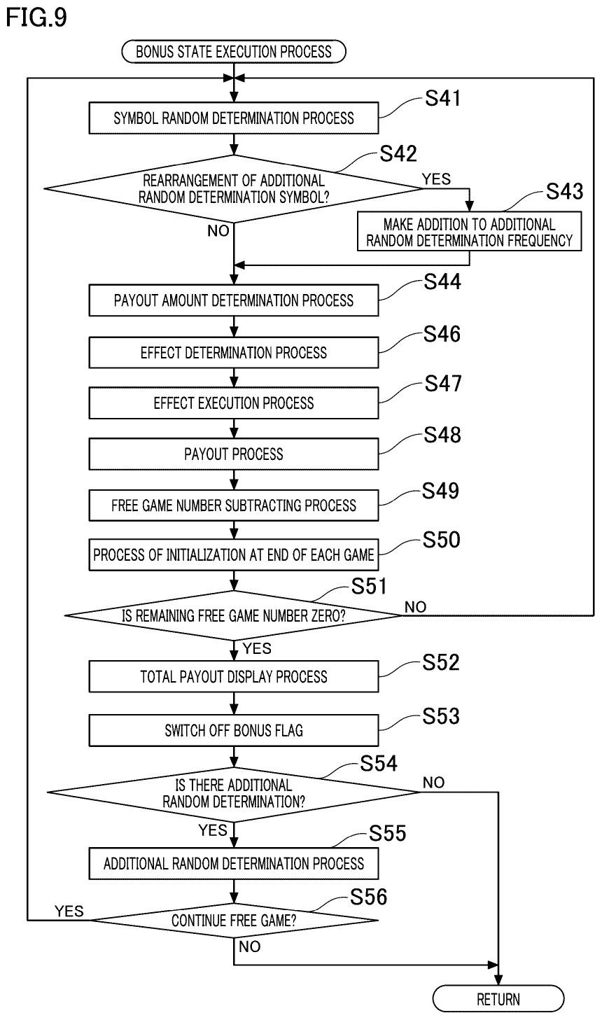

Thereafter, the CPU 101 determines whether the bonus flag is turned on (S23). When the bonus flag is turned off (NO in S23), this routine is terminated. When the bonus flag is turned on (YES in S23), the CPU 101 executes a bonus state execution process (S24). The bonus state execution process will be described later with reference to FIG. 9. As such, after determining that the bonus flag is turned on, the CPU 101 fixes the shift from the normal game to the bonus state. Then the CPU 101 executes a reset process (S25). In the reset process, for example, the CPU101 resets the expansion of the entire columns after the shift to the bonus state. Furthermore, for example, the CPU 101 resets the expansion of the column where the special symbol 501 is rearranged, when a benefit of replacement to the wild symbol 502 is awarded. When no benefit is awarded, the CPU 101 does not execute the reset process.

The following will describe a benefit determination process executed by the CPU 101 of the information processor 1, with reference to FIG. 8.

To begin with, the CPU 101 determines whether the special symbol 501 is to be rearranged in the third scroll area 213 (S30). If the special symbol 501 is rearranged in the third scroll area 213 (YES in S30), the CPU 101 performs a benefit random determination process (S31). In the benefit random determination process, the CPU 101 determines whether the benefit is replacement of a to-be-rearrangement symbol 500 with the wild symbol (see FIG. 5) or shift to the bonus state (see FIG. 6).

When shifting to the bonus state (YES in S32), the CPU 101 turns on the bonus flag (S33). In the step S30, if the special symbols 501 are rearranged in the second scroll area 212 and the fourth scroll area 214 instead of the third scroll area 213 (NO in S30), or if the shift to the bonus state does not occur in the step S32, the CPU 101 determines which symbol 500 among the symbols 500 rearranged in the symbol display area 21 will be replaced with the wild symbol 502 (S34). After the step S33 or the step S4, the CPU 101 finishes the present routine.

The following will describe a first bonus state execution process executed by the CPU 101 of the information processor 1, with reference to FIG. 9.

To begin with, the CPU 101 executes the symbol random determination process in the same manner as in the game control process (S41). The CPU 101 then determines whether an additional random determination symbol has been rearranged (S42). When the additional random determination symbol has been rearranged (YES in S43), the CPU 101 makes addition to an additional random determination frequency (S43). When no additional random determination symbol is rearranged (NO in S43), or after the step S43, the CPU 101 performs a payout amount determination process based on a result of the symbol random determination process (S44). In this process, a payout amount (payout value) is determined so as to correspond to the number (e.g., three to five) of symbols of each type which are to be rearranged (displayed) on a payline in the symbol display area 21, with reference to the paytable stored in the RAM 103. The determined payout amount (payout) in total is stored in the payout amount storage area in the RAM 103.

Although not illustrated, when it is determined in the symbol random determination process in the step S41 that the special symbol 501 is to be rearranged, for example, a process of replacing a to-be-rearranged symbol 500 with the wild symbol 502 may be performed.

The CPU 101 then executes an effect determination process (S46). The CPU 101 samples an effect-use random number, randomly determines any of a plurality of predetermined effect contents, and executes the determined effect content at the determined time (S47). For example, the CPU 101 displays an effect image in the display 2 and outputs sound by means of the speaker 115. Furthermore, for example, the CPU 101 displays an image in which symbols on reels in the symbol display area 21 are scrolled and then to-be-stopped symbols are stopped. For another example, the CPU 101 displays an image in which symbols regarding winning are highlighted among stopped symbols and performs an effect of incrementing an owned credit amount. After that, when there is a credit amount to be added as a result of a game, the CPU 101 executes the payout process of adding this credit amount to an owned credit amount (S48).

The CPU 101 then executes a free game number subtracting process (S49). To be more specific, the CPU 101 subtracts one from a value on a free game remaining number column. The CPU 101 then performs a process of initialization at the end of each game (S50). In the step S50, for example, the CPU 101 clears data which is stored in the working area of the RAM 103 and which becomes unnecessary at the end of each unit game. Examples of the data include data in the executed unit game such as (i) a value on the bet counter of the bet storage area and (ii) a symbol column randomly determined to be displayed in the symbol display area 21.

The CPU 101 then determines whether the remaining number of free game plays in the bonus state is zero (S51). When the remaining number of free game plays is not zero (NO in S51), the CPU 101 shifts the process to the step S44 and executes the free game again. When the remaining number of free game plays is zero (YES in S51), the CPU 101 executes a total payout display process (S52). In the total payout display process, the CPU 101 executes an effect of displaying a total value of all payouts having been paid out in the free game in the first bonus state. After turning off the bonus flag (S53), the CPU 101 determines whether there is additional random determination added thanks to the rearrangement of the additional random determination symbol 503 (S54). When there is additional random determination (YES in S54), the CPU 101 executes the additional random determination process for the added number of times (S55). For example, in the additional random determination process, the CPU 101 randomly determines whether to continue the free game and the number of times of execution of the free games when continued. When the additional random determination process is executed, the continuation of the free game may always be awarded.

The embodiment of the present invention thus described above solely serves as a specific example of the present invention, and is not to limit the scope of the present invention. The specific structures and the like are suitably modifiable. Further, the effects described in the embodiment of the present invention described in the above embodiment are no more than examples of preferable effects brought about by the present invention, and the effects of the present invention are not limited to those described hereinabove.

What is claimed is:

1. An information processor comprising:
a display device which is configured to display a symbol display area where symbols are respectively rearranged in cells arranged to form a matrix with plural rows and plural columns; and
a controller which is configured to run a unit game in which the symbols are rearranged in the symbol display area of the display device,
the controller being configured to execute processes of:
determining, when a special symbol is rearranged in the symbol display area in the unit game, whether the number of the cells in a column where the special symbol is rearranged is the maximum number;
when the number of the cells is not the maximum number, cumulatively increasing the number of the cells in the column where the special symbol is rearranged, in subsequent execution of the unit game; and
when the number of the cells is the maximum number, awarding a benefit.

2. The information processor according to claim 1, wherein,
columns in each of which the number of the cells is cumulatively increased are continuously provided among the columns.

3. The information processor according to claim 1, wherein,
columns in each of which the number of the cells is cumulatively increased are not outermost columns among the columns in the symbol display area.

4. The information processor according to claim 1, wherein,
when the benefit is awarded, the controller resets the columns in the symbol display area to an initial state that is before cumulative increase of the number of the cells.

5. A game control method executed by a computer, comprising the steps of:
displaying, on a display device, a symbol display area where symbols are respectively rearranged in cells arranged to form a matrix with plural rows and columns;
running a unit game in which the symbols are rearranged in the symbol display area of the display device;
determining, when a special symbol is rearranged in the symbol display area in the unit game, whether the number of the cells in a column where the special symbol is rearranged is the maximum number;
when the number of the cells is not the maximum number, cumulatively increasing the number of the cells in the column where the special symbol is rearranged, in subsequent execution of the unit game; and
when the number of the cells is the maximum number, awarding a benefit.

6. A computer-readable non-transitory recording medium storing a game program which causes a computer including a display device to execute the steps of:
displaying a symbol display area where symbols are respectively rearranged in cells arranged to form a matrix with plural rows and columns;
running a unit game in which the symbols are rearranged in the symbol display area of the display device;
determining, when a special symbol is rearranged in the symbol display area in the unit game, whether the number of the cells in a column where the special symbol is rearranged is the maximum number;
when the number of the cells is not the maximum number, cumulatively increasing the number of the cells in the column where the special symbol is rearranged, in subsequent execution of the unit game; and
when the number of the cells is the maximum number, awarding a benefit.
